(19) United States
(12) Patent Application Publication
(10) Pub. No.: US 2024/0408424 A1
(43) Pub. Date: Dec. 12, 2024

(54) Advanced Guidance and Angle Restriction in a Height Safety Apparatus

(71) Applicant: MSA Europe GmbH, Rapperswill-Jona (CH)

(72) Inventors: Elliott Raine, Devizes (GB); Eric Holtkamp, Berlin (DE); Wolfgang Weber, Berlin (DE); Paul Fischer, Berlin (DE)

(21) Appl. No.: 18/812,007

(22) Filed: Aug. 22, 2024

Related U.S. Application Data
(63) Continuation-in-part of application No. PCT/EP2023/078981, filed on Oct. 18, 2023.

(30) Foreign Application Priority Data
Oct. 28, 2022 (DE) 10 2022 128 717.3

(51) Int. Cl. A62B 35/00

(52) U.S. Cl. CPC A62B 35/0087

(57) ABSTRACT

A load transfer device includes a first rotary member and a second rotary member, each of which comprise a plurality of radially projecting petals having a cutout area configured to receive a local portion of an elongated support member. A link body is connected to the first rotary member and the second rotary member. The link body includes a connecting eye configured to attach a load to the load transfer device. A link blocker is connected to the link body. The link blocker has a first blocking member on a first side of the link blocker and a second blocking member on a second side of the link blocker. The first blocking member and the second blocking member are configured to prevent access of lateral portions of the elongated support member to the cutout areas of the radially projecting petals.

### CROSS REFERENCE TO RELATED APPLICATIONS

This application is a continuation-in-part of PCT Application PCT/EP2023/078981, filed Oct. 18, 2023, which claims priority to German Application DE 10 2022 128 717.3, filed Oct. 28, 2022, each of which is incorporated herein by reference in their entirety.

### SPECIFICATION

Load transfer devices are a form of height safety equipment. Such devices are used to traverse elongated support members (e.g., safety lines or cables). Elongated support members are commonly supported along their length by intermediate support brackets and are used to support loads or persons. For example, elongated support member may be used to support and guide users traveling at an elevated height. Load transfer devices are commonly used to attach to the elongated support member and allow a user to travel along its path and over the intermediate support brackets.

### SUMMARY

Systems and methods are provided for a load transfer device that includes a first rotary member and a second rotary member, each of which comprise a plurality of radially projecting petals having a cutout area configured to receive a local portion of an elongated support member. A link body is connected to the first rotary member and the second rotary member. The link body includes a connecting eye configured to attach a load to the load transfer device. A link blocker is connected to the link body. The link blocker has a first blocking member on a first side of the link blocker and a second blocking member on a second side of the link blocker. The first blocking member and the second blocking member are configured to prevent access of lateral portions of the elongated support member to the cutout areas of the radially projecting petals.

In another example, a method of operating a load transfer device includes receiving a local portion of an elongated support member at cutout areas of a first rotary member and a second rotary member when a link blocker of the load transfer device is in a first position. A load is attached to a connecting eye of a link body of the load transfer device when the link blocker is in a second position. Lateral portions of the elongated support member are prevented, with the link blocker, from accessing the cutout areas. The elongated support member is traversed with the load transfer device.

### BRIEF DESCRIPTION OF DRAWINGS

FIG. 1 is a diagram depicting a safety line system securing a person performing construction operations at the top of a structure.

FIG. 2 is a diagram depicting a load transfer device attached to an elongated support member.

FIG. 3 is a diagram depicting a cross-sectional side view of a load transfer device.

FIG. 4 is a diagram depicting a load transfer device with a rotated retention member.

FIG. 5 is a diagram depicting a cut-away front view of a load transfer device.

FIG. 6 is a diagram depicting a front view of a first position of a load transfer device.

FIGS. 7A and 7B are diagrams depicting a top view of a rotation of the load transfer device in a first position.

FIGS. 8A and 8B are diagrams depicting the retention member rotating downwards to support the elongated support member.

FIGS. 9A and 9B are diagrams depicting a rotation of a load transfer device after the retention member has rotated downwards.

FIGS. 10A and 10B are diagrams depicting a movement of a load transfer device from a first position to a second position.

FIG. 11 is a diagram depicting an embodiment of a load transfer device with a link blocker having two legs.

FIG. 12 is a flow diagram depicting a method of operating a load transfer device.

FIG. 13 is a diagram depicting a cut-away front view of an example load transfer device.

FIG. 14 is a diagram depicting a bottom view of an example load transfer device.

FIG. 15 is a diagram depicting a cut-away front view of an example load transfer device in a second position with an elongated support member.

FIG. 16 is a flow diagram depicting a method of operating a load transfer device.

### DETAILED DESCRIPTION

A load transfer device can allow a user to traverse an elongated support member and intermediate support brackets along its length. Some load transfer devices may include many parts and require complicated methods of attachment to the elongated support member. Certain systems and method involve parts of load transfer devices that operate independently, mandating that multiple individual parts of the load transfer device be moved to a particular position to operate the load transfer device. Such systems and methods can render operation of the load transfer device cumbersome. Moreover, substantial numbers of parts in load transfer devices can increase the probability that a given individual part will become defective, thereby decreasing the reliability of the device. Systems and methods that require minimal manual movement of individual components and decrease the total number of parts employed may be beneficial.

Systems and methods provided herein, in embodiments, provide simple and fast operation of a load transfer system. Such simple operation may be convenient and valuable to users because more time may be spent by the user performing commercially productive activities. Furthermore, systems and methods provided herein, in embodiments, involve fewer parts than other systems and methods. Such systems and methods of the present disclosure may thus allow greater time intervals between required maintenance due to a decrease in the frequency of failed components. A decrease in required maintenance can decrease costs and increase operating time of users, which can increase profits.

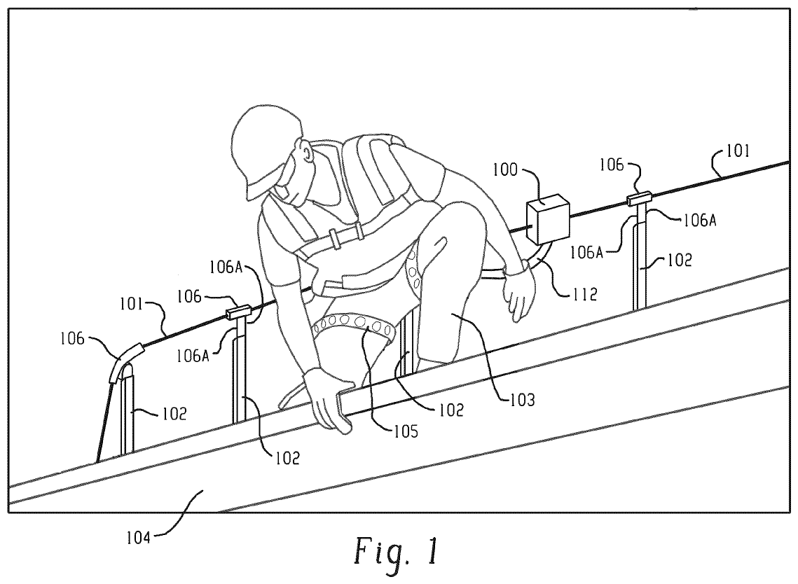

FIG. 1 is a diagram depicting a safety line system securing a person performing construction operations at the top of a structure. The system includes an elongated support member 101. In the example of FIG. 1, the elongated support member 101 is positioned above the structure 104. In some examples, the elongated support member 101 is attached to the structure 104. For example, a support post 102 may be used to attach the elongated support member 101 to the structure 104. In some examples, the elongated support member 101 may be attached to the structure by the use of an intermediate support bracket 106. Intermediate support brackets 106 may be positioned along the structure 104 to fix the elongated support member 101 to the structure 104 at one or more locations. A user 103 may be secured to the elongated support member 101. For example, a load transfer device 100 may be attached to the elongated support member. An attachment mechanism such as a carabiner (not shown) may be secured to the load transfer device 100. A user 103 may wear personal protective equipment (PPE) (e.g., harness) 105 which can be attached to a lanyard 112 which can in turn be fastened to the load transfer device 100. Because the elongated support member 101 is securely attached to the structure 104, the safety line system can secure the user 103 to an area close to the structure 104 and thus protect a user 103 if they slip or fall.

The load transfer device 100 makes direct contact with the structural component (e.g., the elongated support member 101) to which the user 103 is attached. Systems and methods of the present disclosure provide a load transfer device 100 which is reliable and maintains a secure connection with the elongated support member 101 throughout operation and that is also easily attachable to and detachable from the elongated support member 101 when it is intended to be attached and detached. Furthermore, systems and methods of the present disclosure provide a load transfer device 100 that involves a simple structure that requires minimal maintenance.

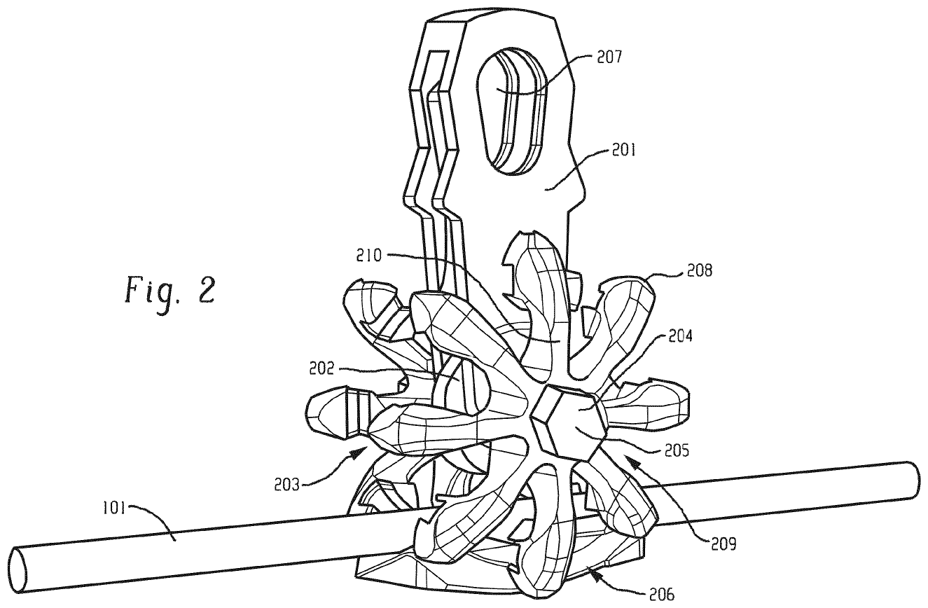

FIG. 2 is a diagram depicting a load transfer device attached to an elongated support member. The load transfer device 100 comprises a link body 201 and a link blocker 202 coupled to the link body 201. The link body 201 may include a connecting eye 207 which can be used to attach a load to the load transfer device 100. For example, a carabiner (not shown) can be attached to the connecting eye 207. The carabiner may be used to secure a person to the load transfer device 100 via a connecting strap (e.g., lanyard). The link body 201 and link blocker 202 may be positioned between a first and second rotary member 203. The rotary members 203 may each include a plurality of radially projecting petals 208. In the example depicted in FIG. 2, the load transfer device 100 includes first and second rotary members 203 with eight radially projecting petals 208. However, some example embodiments include rotary members 203 with a fewer or greater number of radially projecting petals 208. The rotary members 203 may also include a cover member (not shown) located on an external side of each of the rotary members 203 and covering a base portion 210 of the radially projecting petals 208. A recess (e.g., space) 209 may be located between each of the radially projecting petals 208. The recess 209 can be used to traverse the intermediate support brackets 106 that are placed along the length of the elongated support member (e.g., cable) 101. The spaces 209 between the petals 208 may allow connection elements 106a connecting the support bracket 106 to a support post 102 to be received in the spaces 209.

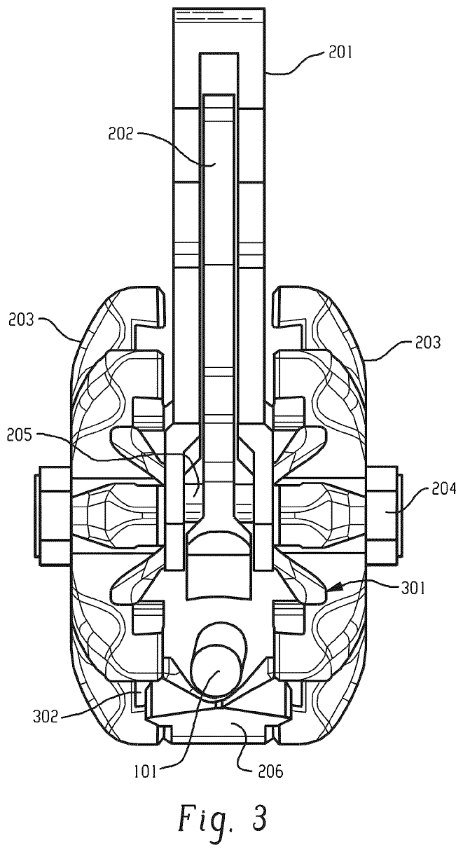

If a recess 209 of one or more of the rotary members 203 is not in register with a bracket leg of the intermediate support bracket 106 as the load transfer device 100 approaches the bracket, contact between a tip of the radially projecting petal 208 and the bracket leg can cause the respective rotary member 203 to rotate slightly and bring a recess 209 into alignment with the leg. The first and second rotary members 203 may share an axis. An axle (e.g., bolt) 205 may extend through this axis. In addition, the link body 201 and the link blocker 202 may also be coupled to this axis and rotate around the axle 205. A securing element (e.g., nut) 204 can be used to secure the first and second rotary members 203, the link body 201 and the link blocker 202 to the axle 205. The axle 205 may include a single threaded end such that a single securing element 204 can be used to secure the components of the load transfer device 100 to the axle 205. Alternatively, the axle 205 may include threads on two separate ends, and two separate securing elements 204 may be provided on each end to secure the components to the axle 205. The load transfer device may also include a retention member 206, which is discussed further below with respect to FIG. 3. The retention member 206 can rotate around axis relative to the link body 201 as discussed later in more detail.

FIG. 3 is a diagram depicting a side view of a load transfer device. In the example embodiment of FIG. 3, the axle 205 extends through the first and second rotary members 203. The link blocker 202 may be located in an interior cavity (e.g., slot) of the link body 201. In other examples, the link blocker 202 is coupled to an exterior of the link body 201. The retention member 206 may be used to support the elongated support member 101 during operation and may also be used to align the load transfer device 100 with intermediate support brackets 106. The retention member 206 may include a pair of side projections which fit into and are supported by one or more notches 302 located within each of the radially projecting petals 208 of the rotary members 203. Each of the radially projecting petals 208 may also include a cutout area 301 that can be used to support the elongated support member 201 when the load transfer device 100 is in a first position and the load transfer device 100 is rotated about an axis extending perpendicularly to the elongated support member 101, as discussed further below. This cutout area 301 may be located in a root portion of the respective petal. In other words, the cutout area 301 may be located closely to the axle 205.

In the example of FIG. 3, the load transfer device 100 is in a second position, as described further below. In the second position, the link blocker 202 may prevent the elongated support member 101 from moving towards the axle 205 to a point at which the elongated support member 101 could be accommodated in the cutout area 301 between the axle 205 and the retention member 206. This may be useful during operation because the device 100 will remain substantially aligned when traversing the elongated support member 101 and will provide for steady and reliable usage. The notches 302 used to support the retention member 206 may be located further away from the axle 205 than the cutout area 301.

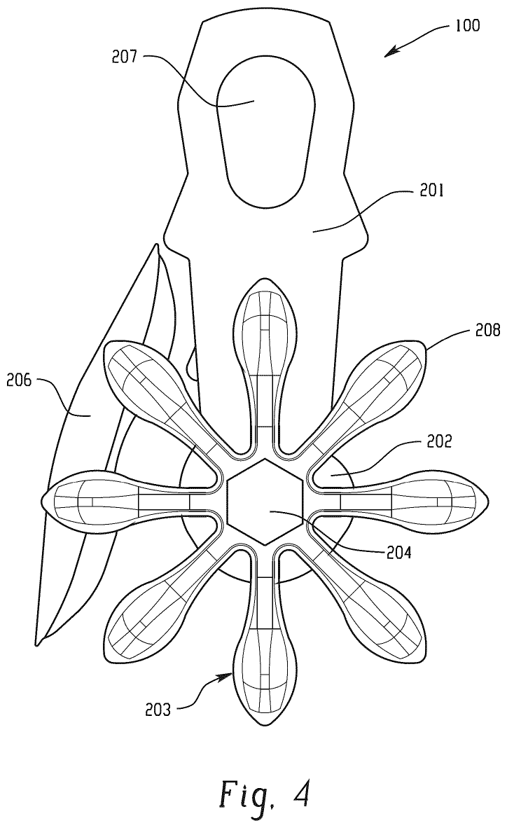

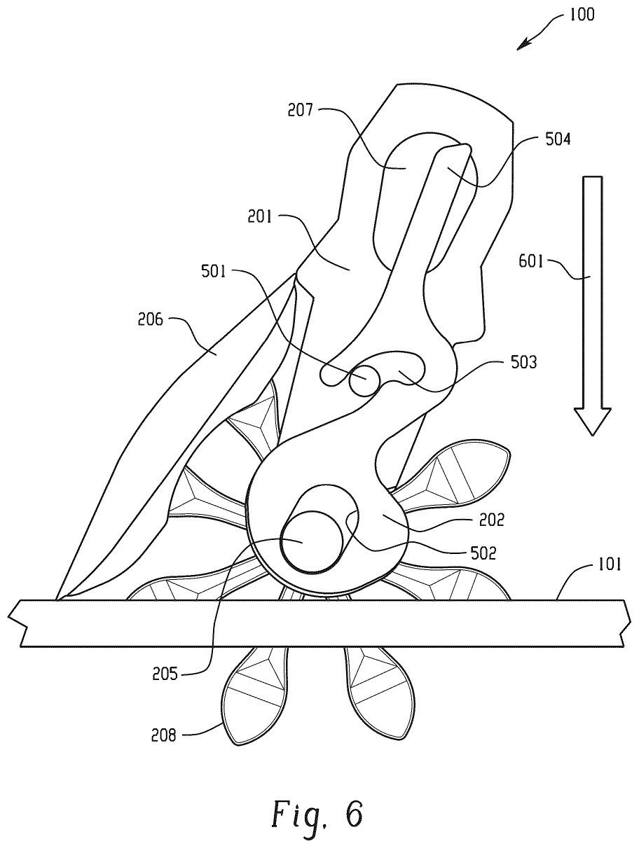

FIG. 4 is a diagram depicting a load transfer device with a rotated retention member. As discussed above, the retention member 206 can be supported by notches 302 located within each of the plurality of radially projecting petals 208. Thus, the retention member 206 can be rotated around the axle 205 to different positions within the load transfer device 100 by rotating to and being supported by different radially projecting petals 208. Rotation of the retention member 206 to the position depicted in FIG. 4 can allow the elongated support member 101 (not shown) to make contact with the link blocker 202. Such a position of the retention member 206 may be advantageous in attaching the load transfer device 100 to the elongated support member 101, as discussed below with reference to FIG. 6. As explained below the link blocker may be moved from a first position to a second position and vice versa. In FIG. 4 the link blocker is shown in the second position.

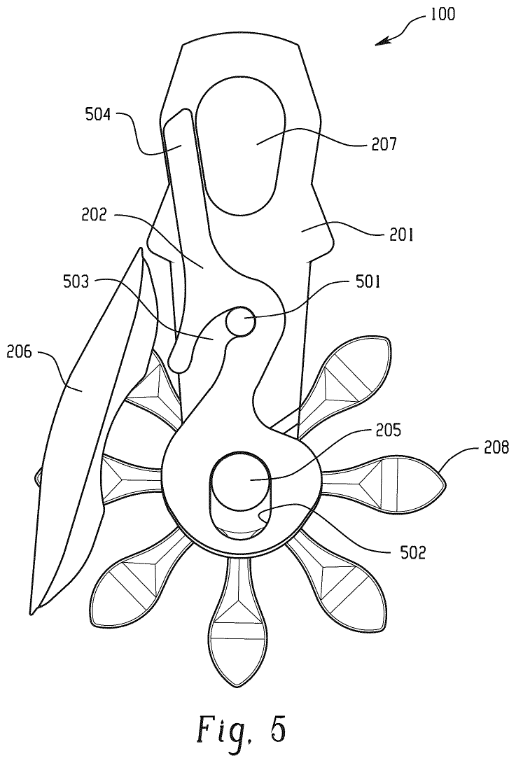

FIG. 5 is a diagram depicting a cut-away front view of a load transfer device. In the example shown in FIG. 5, the arrangement of the retention member 206 as well as the link blocker 202 in relation to the link body 201 is illustrated. The retention member 206 can be rotated around axle 205 independent from the position of the link blocker 202. The link blocker 202 may be movable from the first position shown in FIG. 6 to the second position shown in FIG. 5 and vice versa, as explained below. The movement of the retention member 206 may be independent from the movement of the link blocker 202. The link blocker 202 may include an oblong slot 502 that surrounds the axle 205. In the example depicted in FIG. 5, the load transfer device 100 is in an upright position. This position permits a top side of the oblong slot 502 to rest against an upper side of the axle 205 due to the gravitational force on the link blocker 202. A gap in a lower portion of the oblong slot 502 is located under the axle 205. The link blocker 202 may also include a guidance slot 503. The guidance slot 503 may be coupled to a central pin 501 on the link body 201. The link blocker 202 may also include one or more legs 504 that can be used to prevent access to the connecting eye 207 of the link body 201. In embodiments, the central pin 501 can be used to guide the link blocker 202 to toggle between a first position and a second position, as discussed further below. The guidance slot 503 of the link blocker 202 may be substantially “S”-shaped, as depicted in the example embodiment of FIG. 5. Furthermore, the guidance slot 503 can include a first end in an interior of the link blocker 202 and a second end exposed to an exterior of the link blocker 202. In other example embodiments, the guidance slot 503 may be shaped differently and may not be exposed to an exterior of the link body 202.

When a force (e.g., an upward force) is applied to the link blocker 202, the oblong slot 502 may move upwards relative to the axle 205. The force may be provided, for example, by pressing the load transfer device against the elongated support member 101. Simultaneously, the central pin 501 may guide the link blocker 202 to rotate and move upwards relative to the link body 201. In the example depicted in FIG. 5, the central pin 501 will guide the link blocker 202, which is in the second position in FIG. 5, to rotate clockwise relative to the link body 201. Thus, the leg 504 of the link blocker 202 may move to a position that obstructs access to the connecting eye 207. This position may be a referred to as a first position. When the load transfer device 100 is in this first position, a lower side of the link blocker 202 may be sufficiently close to the axle 205 to allow the elongated support member 101 to enter into the cutout area 301 when the device 100 is rotated when in contact with the elongated support member 101.

FIG. 6 is a diagram depicting a front view of a first position of a load transfer device. FIGS. 6 through 10B collectively depict an example process by which the load transfer device 100 may be attached to the elongated support member 101. As shown in FIG. 6, when a force (e.g., an upper force) is applied to the link blocker 202, the oblong slot 502 moves upward relative to the axle 205 to get into the first position. A lower side of the oblong slot 502 then rests against the axle 205. This force may be applied by pressing the link blocker 202 against the elongated support member 101, as depicted by the downward arrow 601 of FIG. 6. As the force is being applied, the central pin 501 guides the link blocker 202 to a first position in which the leg 504 of the link blocker 202 blocks the connecting eye 207 of the link body 201. When the load transfer device 100 is in the position depicted in FIG. 6, a load or carabiner may not be able to attach to the connecting eye 207. Simultaneously, the link blocker 202 can allow access to the cutout area 301 by the elongated support member 101. Specifically, the elongated support member 101 may attain a position sufficiently near the axle 205 to be at the same or similar level as the cutout area 301 of the rotary members 203. As shown in FIG. 6, the retention member 206 can be rotated to a position in which the elongated support member 101 can contact the link blocker 202.

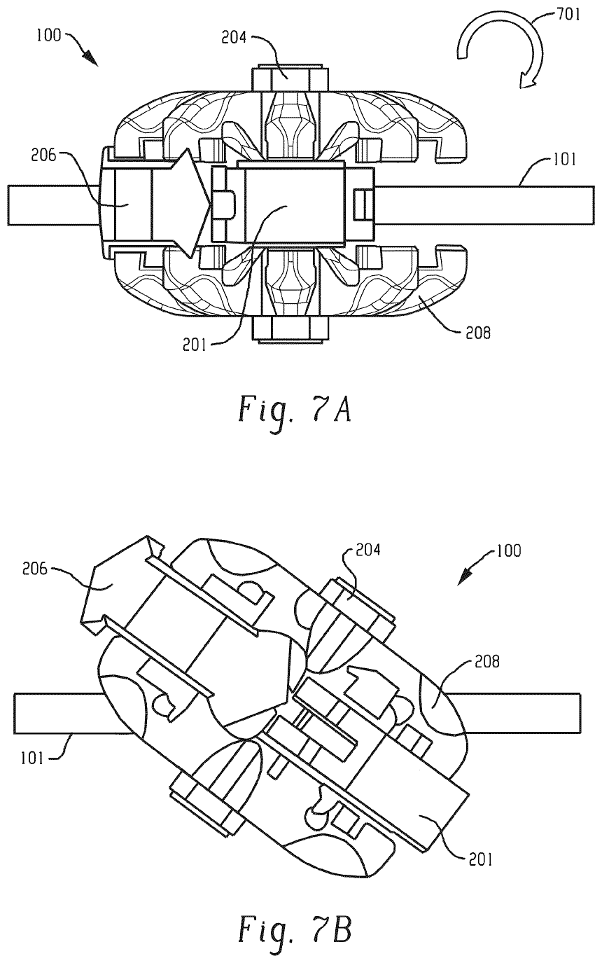

FIGS. 7A and 7B are diagrams depicting a top view of a rotation of the load transfer device in a first position. In the example shown in FIG. 7A, the link blocker 202 is in the first position in which access to the connecting eye 207 is blocked by the leg 504 but the load transfer device 100 may be connected to or disconnected from the elongated support member 101. Furthermore, the top view illustrated in FIG. 7A demonstrates that the retention member 206 is located in an upper position relative to the elongated support member 101. As shown by the arrow 701, the load transfer device 100 can then be rotated around an axis (not shown) that extends perpendicularly from the elongated support member 101. In the example of FIG. 7A, this axis can be visualized as being located in a center of the load transfer device 100 and extending outward through the top of the device 100. FIG. 7B is a diagram depicting a top view of a first position of a load transfer device after it has been rotated about the axis extending perpendicularly from the elongated support member. In the example depicted in FIG. 7B, the elongated support member 101 is accommodated in a cutout area 301 of the rotary members 203. In FIG. 7B, the link blocker may be still in the first position.

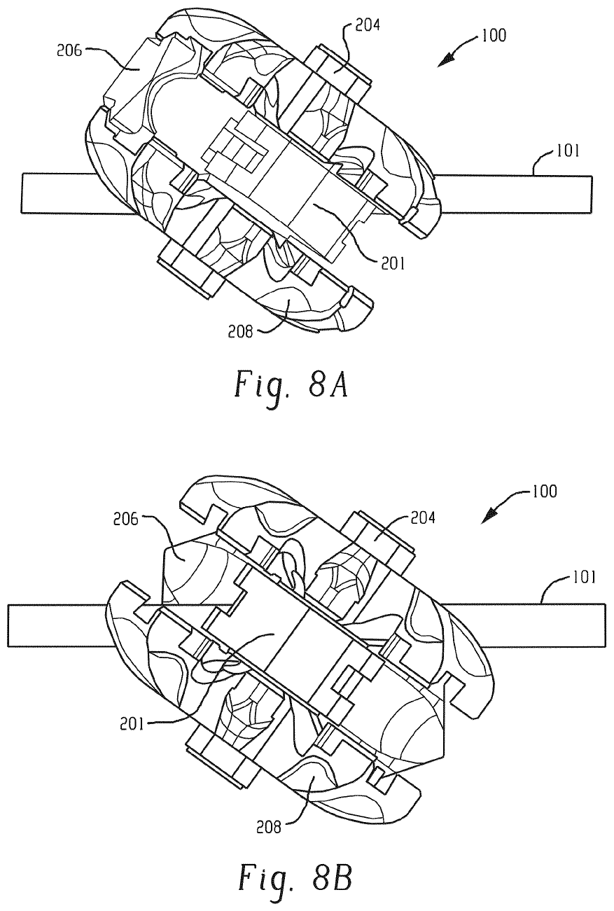

FIGS. 8A and 8B are diagrams depicting the retention member rotating downwards to support the elongated support member. The retention member 206 may rotate downwards due to an effect from gravity, or the retention member 206 may be intentionally pushed or swung into a position in which it supports the elongated support member 101. In the example of FIG. 8A, the retention member 206 is located in an intermediate position in which it is falling downwards to support the elongated support member 101. In the example of FIG. 8B, the retention member 206 is located in a lower position and is supporting the elongated support member 101. In the examples of FIGS. 8A and 8B, the elongated support member 101 may be positioned within the cutout areas 301 of the first and second rotary members 203, as illustrated above in the description corresponding to FIG. 3. After the retention member 206 falls to the lower position, the link blocker 202 may still be in the first position.

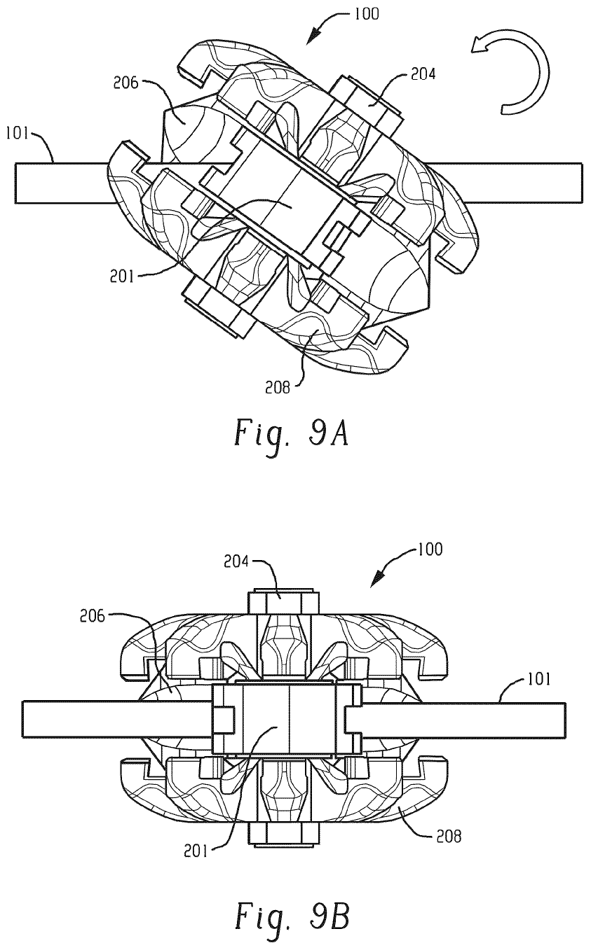

FIGS. 9A and 9B are diagrams depicting a rotation of a load transfer device after the retention member has rotated downwards. After the retention member 206 has rotated downwards, the load transfer device 100 can then be rotated about the axis extending perpendicularly from the elongated support member 101. In the example shown in FIGS. 9A and 9B, the load transfer device 100 is rotated counter-clockwise. This can allow the elongated support member 101 to be placed directly above the retention member 206, as shown in FIG. 9B. This position can allow the load transfer device 100 to travel along the length of the elongated support member 101.

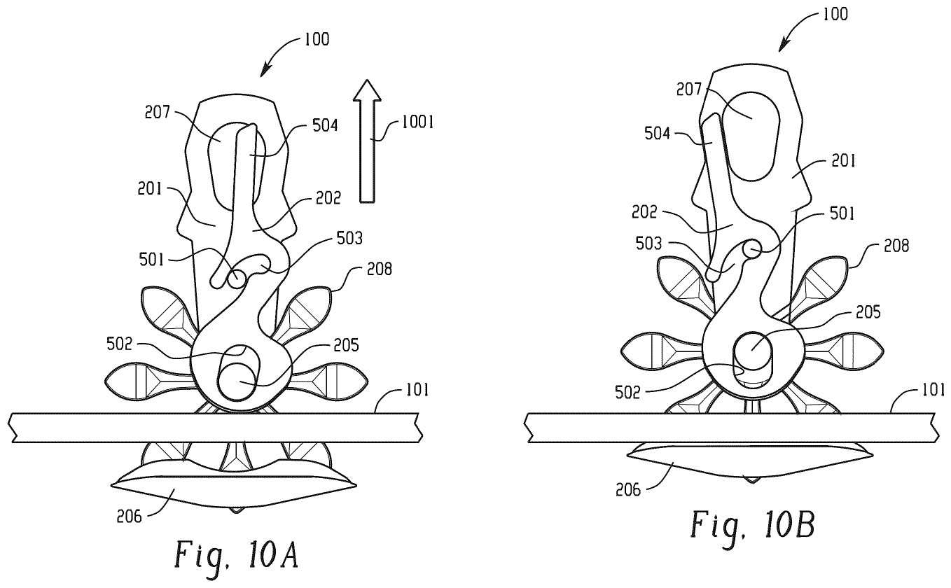

FIGS. 10A and 10B are diagrams depicting a movement of a load transfer device from a first position to a second position. FIG. 10A depicts a front cut-away view of the position of the load transfer device 100 after the retention member 206 has rotated to a lower position (e.g., the same arrangement illustrated in FIG. 9B). As demonstrated by FIG. 10A, the elongated support member 101 is in contact with a lower portion of the link blocker 202, which causes the leg 504 of the link blocker 202 to block the connecting eye 207 of the link body 201 and prevent attachment of a load to the connecting eye 207. As depicted by the arrow 1001 of FIG. 10A, the load transfer device 100 can be pulled up, or otherwise caused to move upward relative to the elongated support member 101.

This movement depicted by the arrow 1001 can occur naturally (e.g., by gravity's effect on either the load transfer device 100 or the elongated support member 101), or can be caused intentionally by pulling the load transfer device 100. When the elongated support member 101 moves down relative to the load transfer device 100, the oblong slot 502 may move downward relative to the axle 205, causing the upper end of the oblong support member 502 to contact the axle 205. As depicted in FIGS. 10A and 10B, the central pin 501 of the link body 201 simultaneously guides the link blocker 202 to a second position in which access to the connecting eye 207 of the link body 201 is permitted. In this second position, an attachment device such as a carabiner can be utilized to attach a load to the connecting eye 207. Insertion of an attachment device into the connecting eye 207 may prevent movement of the link blocker 202 relative to the link body 201, thereby preventing removal of the elongated support member 101 from the load transfer device 100. FIGS. 10A and 10B demonstrate how the central pin 501, oblong slot 502, and guidance slot 503 operate in conjunction to seamlessly transition between the first and second positions with only a single part (the link blocker 202) coupled to the link body 201. As discussed above, FIGS. 6 through 10B collectively depict an example process by which the load transfer device 100 may be attached to the elongated support member 101.

The load transfer device 100 may be detached from the elongated support member 101 by performing the same steps and methods disclosed above in a differing (e.g., backwards) order. For example, the carabiner or load may be removed from the connecting eye 207 of the load transfer device 100. Thereafter, a force may be applied to the link blocker 202 (e.g., by pressing the load transfer device 100 against the elongated support member 101). This may cause the elongated support member 101 to be sufficiently close to the axle 205 that the cutout area 301 of the radially projecting petals 208 can accommodate the elongated support member 101. The load transfer device may then be rotated about an axis extending perpendicularly to the elongated support member 101, causing the cutout areas 301 to support the elongated support member. At this stage the elongated support member 101 may be at an angle of approximately 45 degrees relative to the direction of the load transfer device 100. When the elongated support member is in this position, the retention member 206 can rotated to an area closer to the link body 201, and the device 100 can be detached from the elongated support member 101. As demonstrated, removal of the load transfer device 100 from the elongated support member 101 may not be possible until a load has been detached from the connecting eye 207 of the link body 201. In this respect, the device may be “fail-safe.”

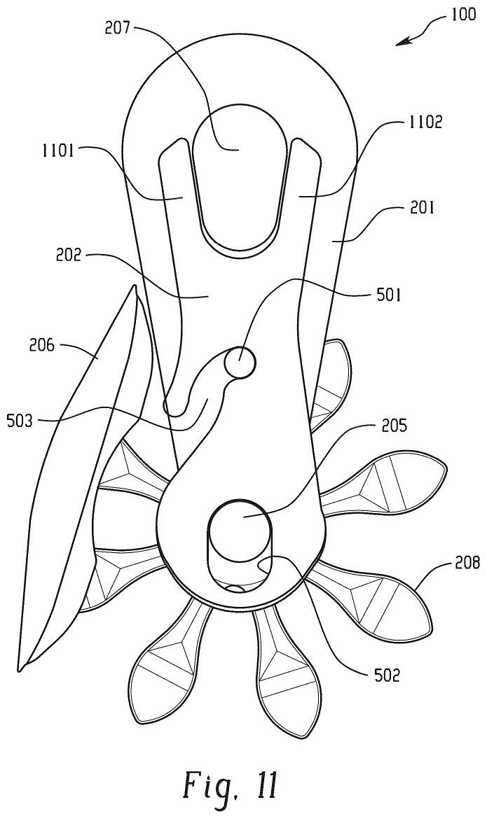

FIG. 11 is a diagram depicting an embodiment of a load transfer device with a link blocker having two legs. In the example shown in FIG. 11, the link blocker 202 of the load transfer device 100 has two legs (1101, 1102). These legs may surround and allow access to the connecting eye 207 when the link blocker 202 is in the second position. When the link blocker 202 is in the first position, a leg (e.g., leg 1101) may block access to the connecting eye 207. The second leg (e.g., leg 1102) may thus protrude from the side of the link body 201 when the link blocker 202 is in the first position. This may allow a user to support the movement of the link blocker 202 from the first position into the second position by pressing the leg into the direction of the link body 201. The other leg may then be moved out of the connecting eye 207 to free the access to the connecting eye 207. In other examples, both legs (1101, 1102) may block access to the connecting eye 207 in the first position. The particular leg that blocks the connecting eye 207 can depend upon the shape and orientation of the guidance slot 503. In other examples, greater than two legs are present on the link blocker 202. As shown in FIG. 11, embodiments in which the link blocker 202 has two or more legs may include similar structural aspects as embodiments involving a single leg. For example, a load transfer device 100 with a link blocker 202 having two or more legs may include a link body 201 with a central pin 501, rotary members 203 with a plurality of radially projecting petals 208, and a retention member 206.

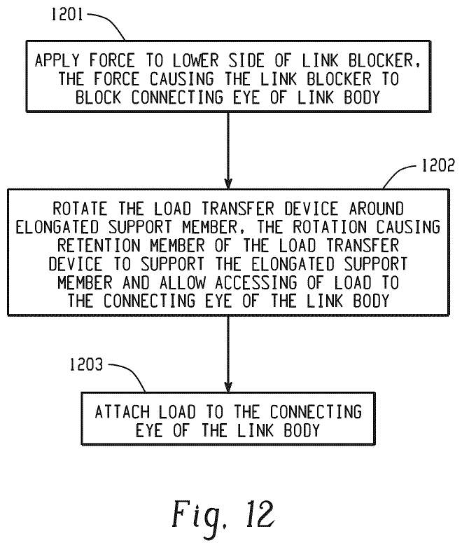

FIG. 12 is a flow diagram depicting a method of operating a load transfer device. The method includes applying a force to a lower side of a link blocker, the force causing the link blocker to block a connecting eye of a link body at 1201. The method further includes rotating the load transfer device around an elongated support member, the rotation causing a retention member of the load transfer device to support the elongated support member and allow accessing of a load to the connecting eye of the link body at 1202. A load is attached to the connecting eye of the link body at 1203. Those of ordinary skill in the art will appreciate that the steps depicted in the example embodiment of FIG. 12 may be performed in an order that differs from that shown in FIG. 12 while remaining within the spirit and scope of the present disclosure. Moreover, those of ordinary skill in the art will recognize that additional steps can be added to the method depicted in FIG. 12 while remaining within the spirit and scope of the present disclosure.

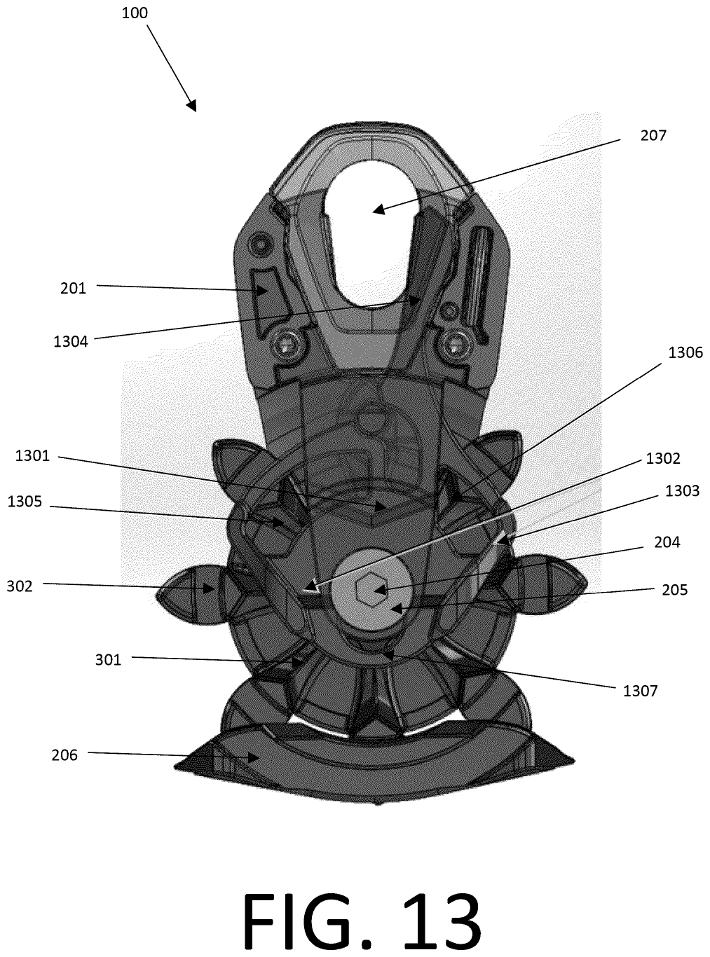

FIG. 13 is a diagram depicting a cut-away front view of an example load transfer device. In embodiments, the load transfer device 100 depicted in FIG. 13 includes an increased area blocking the elongated support member 101 from certain features of the load transfer device 100. Such embodiments may prevent the elongated support member 101 from being jammed or caught in the load transfer device 100 during operation. Furthermore, in embodiments, the example shown in FIG. 13 can limit a vertical angle of the load transfer device 100 relative to the elongated support member 101. This may result in improved safety and a smoother operation of the load transfer device 100, as described further below.

In the example shown in FIG. 13, the load transfer device 100 includes another example embodiment of a link blocker 1301. The link blocker 1301 has a first blocking feature 1302 on a first side of the link blocker 1301 and a second blocking feature 1303 on a second side of the link blocker 1301. The first blocking feature 1302 and the second blocking feature 1303 may extend outwardly from the link blocker 1301. As shown in FIG. 13, the first and second blocking features 1302, 1303 may extend along a bottom of the first side and a bottom of the second side, respectively. Furthermore, the first and second blocking features 1302, 1303 at the first and second sides of the link blocker 1301, respectively, may extend laterally past the cutout areas 301 of the radially projecting petals 208. The first and second blocking features 1302, 1303 may also extend laterally to or past the notches 302 of the radially projecting petals 208.

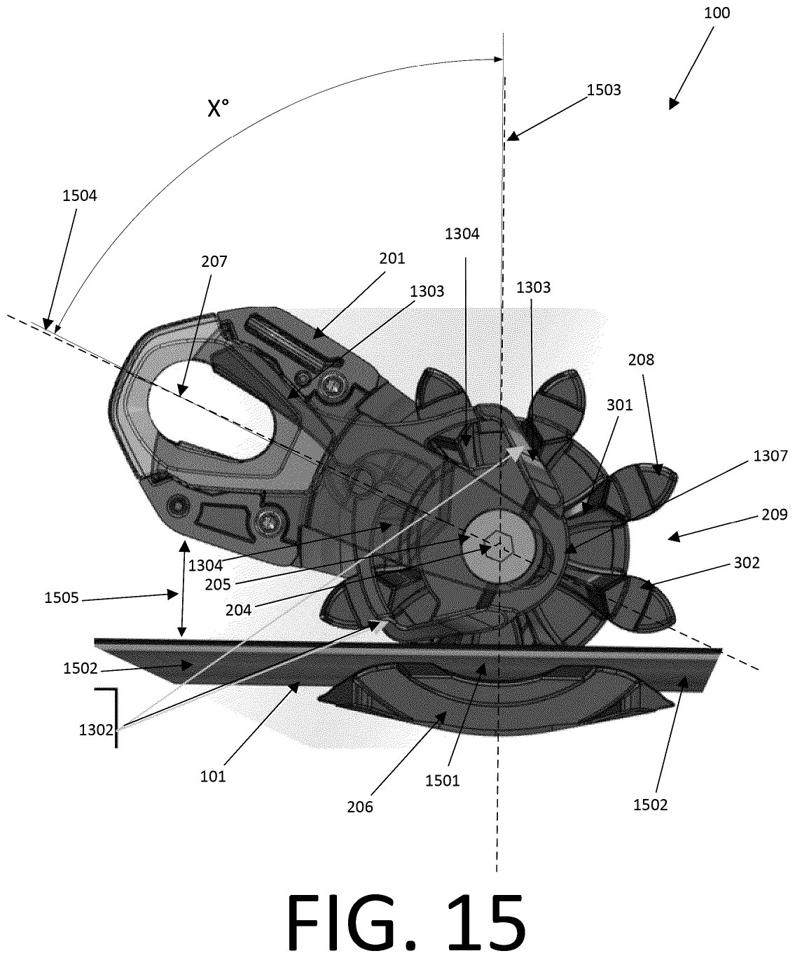

As described further below, the first and second blocking features 1302, 1303 may prevent lateral portions 1502 of the elongated support member 101 (FIG. 15) from accessing certain components of the load transfer device 100, and may assist in keeping the load transfer device 100 in an upright position during operation. For example, because the first and second blocking features 1302, 1303 may extend to or past (e.g., block) the cutout areas 301 and notches 302 of the radially projecting petals 208, the elongated support member 101 may abut the first and second blocking features 1302, 1303 during an operation of the load transfer device 100, rather than becoming caught in the cutout areas 301 and notches 302. In addition, the first and second blocking features 1302, 1303 extend to the recesses 209 between the radially projecting petals 208, thus preventing the elongated support member 101 from being caught in or entangled within the recesses 209.

The link blocker 1301 shown in FIG. 13 includes a first hollow area 1305 on the first side and a second hollow area 1306 on the second side. The first and second hollow areas 1305, 1306 may reduce the material needed to manufacture the link blocker 1301, resulting in reduced cost and weight of the load transfer device 100. Additionally, the link blocker 1301 may include a gap 1307 at a bottom of the link blocker 1301 between the first and second blocking features 1302, 1303, which can result in an easier transition of the link blocker 1301 from the first position to the second position, and vice versa, as described below.

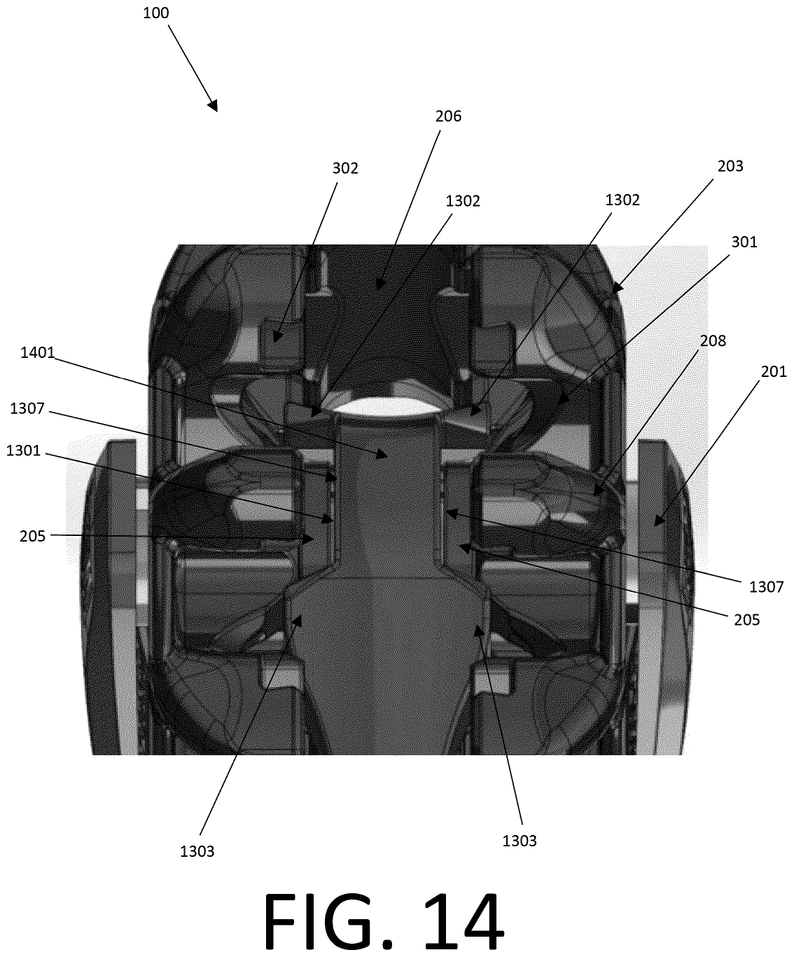

FIG. 14 is a diagram depicting a bottom view of an example load transfer device. As shown in FIG. 14, the first blocking feature 1302 and the second blocking feature 1303 extend outwardly from a central portion 1401 of the link blocker 1301. As described above, the first and second blocking features 1302, 1303 can thus prevent lateral portions 1502 of the elongated support member 101 (FIG. 15) from accessing the cutout areas 301 and the notches 302 of the radially projecting petals 208, as well as the recesses 209 between the radially projecting petals 208. Furthermore, the first and second blocking features 1302, 1303 may result in a lower (e.g., closer to the elongated support member 101) center of gravity of the load transfer device 100 due to the added mass at the bottom of the link blocker 1301. This may result in improved safety and operability of the load transfer device 100. For example, the lower center of gravity may allow a user to rotate the load transfer device 100 over the elongated support member 101 more easily, as compared with a load transfer device having a link blocker 202 without blocking features.

As shown in FIG. 14, the first and second blocking features 1302, 1303 may extend to a distance substantially similar to the depth of the notches 302 of the radially projecting petals 208. This outward extension can assist in preventing the elongated support member 101 from accessing the notches 302. Furthermore, the gap 1307 is present adjacent to the central portion 1401 of the link blocker 1301 and between the first and second blocking features 1302, 1303. When the link blocker 1301 is in the first position, the axle 205 may partially or fully accommodate the gap 1307. The gap 1307 can thus facilitate a smooth transition from the first position to the second position, and vice versa. As shown in FIG. 14, the link body 201 may be placed on external sides of the first and second rotary members 203 in some example embodiments.

FIG. 15 is a diagram depicting a cut-away front view of an example load transfer device in a second position with an elongated support member. As shown in FIG. 15, the retention member 206 supports a local portion 1501 of the elongated support member 101. As described above, the first and second blocking features 1302, 1303 can prevent lateral portions 1502 of the elongated support member 101 (e.g., areas of the elongated support member 101 not connected to the load transfer device 100) from accessing the cutout areas 301 and notches 302 of the radially projecting petals 208, as well as the recesses 209 between the radially projecting petals 208.

Aspects of the operation of the load transfer device 100 depicted in FIGS. 13-15 may be similar to aspects of the operation of the load transfer device 100 depicted in FIGS. 1-11. For example, the link blocker includes a leg 1303 configured to prevent access to the connecting eye 207 when the link blocker 1301 is in a first position. Furthermore, when the link blocker 1301 is in the first position, the link blocker 1301 allows the load transfer device 100 to be connected to or disconnected from the elongated support member 101. Moreover, when the link blocker 1301 is in a second position, the link blocker 1301 may prevent the load transfer device from being connected to or disconnected from the elongated support member 101 and may allow access to the connecting eye 207.

As shown in FIG. 15, the first and second blocking features 1302, 1303 may prevent the load transfer device 100 from rotating more than a predetermined amount clockwise or counterclockwise from a vertical position when the load transfer device 100 is attached to the elongated support member 101. For example, when the load transfer device 100 is in the vertical position, a lengthwise axis 1504 of the link body 201 may be substantially aligned with a vertical axis 1503 (e.g., an axis substantially perpendicular to the elongated support member 101). The first and second blocking features 1302, 1302 may contact the elongated support member 101 when the lengthwise axis 1504 of the link body 201 is rotated a predetermined amount X° from the vertical axis 1503, thus assisting in keeping the load transfer device 100 in an upright position relative to the elongated support member 101. This can assist in providing a smoother operation by reducing the difficulty of rotating the load transfer device 100 around the elongated support member 101. Furthermore, the first and second blocking features 1302, 1303 can increase the distance 1505 of the link body 201 from the elongated support member 101, thus reducing the possibility of the elongated support member 101 being jammed or caught in the cutout areas 301, notches 302, or recesses 209 of the radially projecting petals 208.

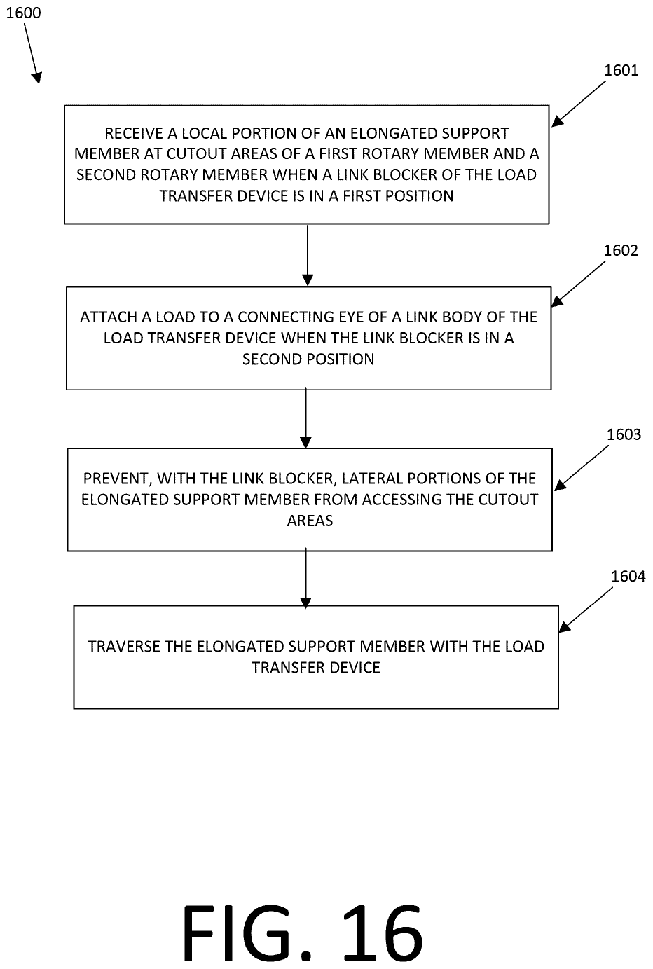

FIG. 16 is a flow diagram depicting a method of operating a load transfer device. The method includes receiving a local portion of an elongated support member at cutout areas of a first rotary member and a second rotary member when a link blocker of the load transfer device is in a first position at 1601. The method further includes attaching a load to a connecting eye of a link body of the load transfer device when the link blocker is in a second position at 1602. The method further includes preventing, with the link blocker, lateral portions of the elongated support member from accessing the cutout areas at 1603. The method further includes traversing the elongated support member with the load transfer device at 1604. Those of ordinary skill in the art will appreciate that the steps depicted in the example embodiment of FIG. 16 may be performed in an order that differs from that shown in FIG. 16 while remaining within the spirit and scope of the present disclosure. Moreover, those of ordinary skill in the art will recognize that additional steps can be added to the method depicted in FIG. 16 while remaining within the spirit and scope of the present disclosure.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

Further advantageous embodiments of the claimed subject matter become apparent from the following clauses:

1. A load transfer device comprising:

a first rotary member and a second rotary member, each of the first and second rotary members configured to receive an elongated support member;

a link body located between the first and second rotary members, the link body including a connecting eye configured to attach a load to the load transfer device;

a link blocker coupled to the link body, the link blocker being configured to toggle between a first position and a second position;
wherein when the link blocker is in the first position, the link blocker allows the load transfer device to be connected to or disconnected from the elongated support member and prevents access to the connecting eye;
wherein when the link blocker is in the second position, the link blocker prevents the load transfer device from being connected to or disconnected from the elongated support member and allows access to the connecting eye;
wherein the link blocker is configured to transition from the second position to the first position when a force is applied to the link blocker.

2. The load transfer device of clause 1, further comprising a retention member extending between the first and second rotary members, wherein the link blocker prevents access to a cutout area of the first and second rotary members by the elongated support member when the elongated support member is positioned between the retention member and the link blocker, and the link blocker is in the second position.

3. The load transfer device of clause 1 or 2, each of the first and second rotary members comprising a plurality of radially projecting petals including a notch at a distal portion of the radially projecting petals, wherein the retention member is supported by the notches.

4. The load transfer device of at least one of the preceding clauses, wherein the first and second rotary members have a common axis of rotation, wherein the load transfer device further comprises an axle extending through the common axis of rotation.

5. The load transfer device of clause 4, the link blocker comprising an oblong slot surrounding the axle, wherein the force applied to the link blocker is applied along a lengthwise axis of the oblong slot.

6. The load transfer device of at least one of the preceding clauses, the link blocker comprising a guidance slot and the link body further comprising a central pin coupled to the guidance slot, the central pin configured to guide the link blocker along the guidance slot when the force is applied to the link blocker.

7. The load transfer device of clause 6, wherein the guidance slot is substantially “S”-shaped.

8. The load transfer device of clause 6 or 7, wherein the guidance slot includes a first end in an interior of the link blocker and a second end exposed to an exterior of the link blocker.

9. The load transfer device of at least one of the preceding clauses, each of the first and second rotary members further comprising a plurality of recesses positioned between the radially projecting petals, the plurality of recesses configured to traverse an intermediate support bracket.

10. The load transfer device of at least one of the preceding clauses, wherein the load transfer device is further configured to travel distally along the elongated support member.

11. The load transfer device of at least one of the preceding clauses, wherein the elongated support member is a safety line or cable.

12. A method of operating a load transfer device comprising:

applying a force to a lower side of a link blocker, the force causing the link blocker to block a connecting eye of a link body;

rotating the load transfer device around an elongated support member, the rotation causing a retention member of the load transfer device to support the elongated support member and allow accessing of a load to the connecting eye of the link body; and

attaching a load to the connecting eye of the link body.

13. The method of clause 12, wherein the force applied to the link blocker is applied along a lengthwise axis of the link blocker, wherein the elongated support member is used to apply the force to the lower side of the link blocker.

14. The method of clause 12 or 13, further comprising rotating the retention member of the load transfer device to expose the link blocker.

15. The method of at least one of the preceding clauses, further comprising traveling distally along the elongated support member and traversing an intermediate support bracket.

16. The method of at least one of the preceding clauses, wherein the step of applying the force to the lower side of the link blocker further comprises guiding, by a guidance slot, the link blocker to a first position.

17. The method of at least one of the preceding clauses, further comprising removing the load transfer device from the elongated support member, wherein removing the load transfer device includes removing the load from the connecting eye of the link body.

18. The method of clause 17, wherein the step of removing the load transfer device from the elongated support member further includes rotating the load transfer device with respect to an axis, the axis extending perpendicularly to the elongated support member.

19. The method of clause 18, wherein the step of removing the load transfer device from the elongated support member further includes rotating the retention member to a first position that exposes the link blocker.

20. The method of one of the preceding clauses, wherein the elongated support member is a safety line or cable.

21. A load transfer device comprising:

a first rotary member and a second rotary member, each of the first and second rotary members comprising a plurality of radially projecting petals, each of the radially projecting petals having a cutout area configured to receive a local portion of an elongated support member;

a link body connected to the first rotary member and the second rotary member, the link body including a connecting eye configured to attach a load to the load transfer device;

a link blocker connected to the link body, the link blocker having a first blocking member on a first side of the link blocker and a second blocking member on a second side of the link blocker, the first blocking member and the second blocking member configured to prevent access of lateral portions of the elongated support member to the cutout areas of the radially projecting petals.

22. The load transfer device of clause 21, wherein the link blocker is configured to toggle between a first position and a second position;

wherein when the link blocker is in the first position, the link blocker allows the load transfer device to be connected to or disconnected from the elongated support member and prevents access to the connecting eye;

wherein when the link blocker is in the second position; the link blocker prevents the load transfer device from being connected to or disconnected from the elongated support member and allows access to the connecting eye;

wherein the link blocker is configured to transition from the second position to the first position when a force is applied to the link blocker.

23. The load transfer device of clause 22, further comprising a retention member extending between the first and second rotary members, wherein the link blocker prevents access to the cutout areas of the radially projecting petals by the local portion of the elongated support member when the elongated support member is positioned between the retention member and the link blocker, and the link blocker is in the second position.

24. The load transfer device of clause 23, each of the first and second rotary members comprising a plurality of radially projecting petals including a notch at a distal portion of the radially projecting petals, wherein the retention member is supported by the notches.

25. The load transfer device of clause 24, wherein the first blocking member and the second blocking member are further configured to prevent access of the lateral portions of the elongated support member to the notches.

26. The load transfer device of at least one of the preceding clauses, wherein the first rotary member and the second rotary member further comprise a plurality of recesses positioned between the radially projecting petals, the plurality of recesses configured to traverse an intermediate support bracket.

27. The load transfer device of at least one of the preceding clauses, wherein the load transfer device is further configured to travel distally along the elongated support member.

28. The load transfer device of clause 26 or 27, wherein the first blocking member and the second blocking member are further configured to prevent access of the lateral portions of the elongated support member to the plurality of recesses.

29. The load transfer device of at least one of the preceding clauses, wherein the first and second blocking member prevent the load transfer device from rotating more than a predetermined amount clockwise or counterclockwise from a vertical position when the load transfer device is attached to the elongated support member.

30. The load transfer device of at least one of the preceding clauses, wherein the first and second rotary members have a common axis of rotation, wherein the load transfer device further comprises an axle extending through the axis of rotation.

31. The load transfer device of at least one of the preceding clauses, the link blocker further comprising a guidance slot and the link body further comprising a central pin coupled to the guidance slot, the central pin configured to guide the link blocker along the guidance slot when the force is applied to the link blocker.

32. A method of operating a load transfer device comprising:

receiving a local portion of an elongated support member at cutout areas of a first rotary member and a second rotary member when a link blocker of the load transfer device is in a first position;

attaching a load to a connecting eye of a link body of the load transfer device when the link blocker is in a second position;

preventing, with the link blocker, lateral portions of the elongated support member from accessing the cutout areas; and

traversing the elongated support member with the load transfer device.

33. The method of clause 32, wherein the link blocker is configured to prevent access to the connecting eye of the link body when the link blocker is in the first position.

34. The method of clause 32 or 33, wherein the link blocker is configured to prevent the load transfer device from being connected to or disconnected from the elongated support member when the link blocker is in the second position.

35. The method of at least one of the preceding clauses, wherein the first rotary member and the second rotary member each include a plurality of radially projecting petals and a plurality of recesses positioned between the radially projecting petals, the plurality of recesses configured to traverse an intermediate support bracket.

36. The method of clause 35, further comprising preventing, with the link blocker, the lateral portions of the elongated support member from accessing the recesses.

37. The method of at least one of the preceding clauses, further comprising supporting a retention member with notches in the first and second rotary members, the retention member configured to support the elongated support member.

38. The method of clause 37, further comprising preventing, with the link blocker, the lateral portions of the elongated support member from accessing the notches.

39. The method of at least one of the preceding clauses, wherein the link blocker includes a first blocking member and a second blocking member, the first and second blocking member preventing the load transfer device from rotating more than a predetermined amount clockwise or counterclockwise from a vertical position when the load transfer device is attached to the elongated support member.

40. The method of at least one of the preceding clauses, further comprising applying a force on a lower side of the link blocker, the force causing the link blocker to transition from the second position to the first position.

The features disclosed in above specification, the claims and the figures can be essential for the claimed subject matter in its different embodiments both separately as well as in any combination.

### REFERENCE SIGN LIST

100 load transfer device
101 support member
102 support post
103 user
104 structure
105 personal Protective Equipment
106 support bracket
106a connection element
112 lanyard
201 link body
202 link blocker
207 connecting eye
203 rotary member
204 securing element
205 axle
206 retention member
207 connecting eye
208 petal
209 recess
210 base portion
301 cut out area
302 notch
501 central pin
502 oblong slot
503 guidance slot
1001 leg
1101 arrow
1101 leg
1102 leg
1201, 1202, 1203 step

1. A load transfer device comprising:
a first rotary member and a second rotary member, each of the first and second rotary members comprising a plurality of radially projecting petals, each of the radially projecting petals having a cutout area configured to receive a local portion of an elongated support member;
a link body connected to the first rotary member and the second rotary member, the link body including a connecting eye configured to attach a load to the load transfer device;
a link blocker connected to the link body, the link blocker having a first blocking member on a first side of the link blocker and a second blocking member on a second side of the link blocker, the first blocking member and the second blocking member configured to prevent access of lateral portions of the elongated support member to the cutout areas of the radially projecting petals.

2. The load transfer device of claim 1, wherein the link blocker is configured to toggle between a first position and a second position;
wherein when the link blocker is in the first position, the link blocker allows the load transfer device to be connected to or disconnected from the elongated support member and prevents access to the connecting eye;
wherein when the link blocker is in the second position; the link blocker prevents the load transfer device from being connected to or disconnected from the elongated support member and allows access to the connecting eye;
wherein the link blocker is configured to transition from the second position to the first position when a force is applied to the link blocker.

3. The load transfer device of claim 2, further comprising a retention member extending between the first and second rotary members, wherein the link blocker prevents access to the cutout areas of the radially projecting petals by the local portion of the elongated support member when the elongated support member is positioned between the retention member and the link blocker, and the link blocker is in the second position.

4. The load transfer device of claim 3, each of the first and second rotary members comprising a plurality of radially projecting petals including a notch at a distal portion of the radially projecting petals, wherein the retention member is supported by the notches.

5. The load transfer device of claim 4, wherein the first blocking member and the second blocking member are further configured to prevent access of the lateral portions of the elongated support member to the notches.

6. The load transfer device of claim 1, wherein the first rotary member and the second rotary member further comprise a plurality of recesses positioned between the radially projecting petals, the plurality of recesses configured to traverse an intermediate support bracket.

7. The load transfer device of claim 6, wherein the load transfer device is further configured to travel distally along the elongated support member.

8. The load transfer device of claim 6, wherein the first blocking member and the second blocking member are further configured to prevent access of the lateral portions of the elongated support member to the plurality of recesses.

9. The load transfer device of claim 1, wherein the first and second blocking members prevent the load transfer device from rotating more than a predetermined amount clockwise or counterclockwise from a vertical position when the load transfer device is attached to the elongated support member.

10. The load transfer device of claim 1, wherein the first and second rotary members have a common axis of rotation, wherein the load transfer device further comprises an axle extending through the axis of rotation.

11. The load transfer device of claim 2, the link blocker further comprising a guidance slot and the link body further comprising a central pin coupled to the guidance slot, the central pin configured to guide the link blocker along the guidance slot when the force is applied to the link blocker.

12. A method of operating a load transfer device comprising:
receiving a local portion of an elongated support member at cutout areas of a first rotary member and a second rotary member when a link blocker of the load transfer device is in a first position;
attaching a load to a connecting eye of a link body of the load transfer device when the link blocker is in a second position;
preventing, with the link blocker, lateral portions of the elongated support member from accessing the cutout areas; and
traversing the elongated support member with the load transfer device.

13. The method of claim 12, wherein the link blocker is configured to prevent access to the connecting eye of the link body when the link blocker is in the first position.

14. The method of claim 12, wherein the link blocker is configured to prevent the load transfer device from being connected to or disconnected from the elongated support member when the link blocker is in the second position.

15. The method of claim 12, wherein the first rotary member and the second rotary member each include a plurality of radially projecting petals and a plurality of recesses positioned between the radially projecting petals, the plurality of recesses configured to traverse an intermediate support bracket.

16. The method of claim 15, further comprising preventing, with the link blocker, the lateral portions of the elongated support member from accessing the recesses.

17. The method of claim 12, further comprising supporting a retention member with notches in the first and second rotary members, the retention member configured to support the elongated support member.

18. The method of claim 17, further comprising preventing, with the link blocker, the lateral portions of the elongated support member from accessing the notches.

19. The method of claim 12, wherein the link blocker includes a first blocking member and a second blocking member, the first and second blocking members preventing the load transfer device from rotating more than a predetermined amount clockwise or counterclockwise from a vertical position when the load transfer device is attached to the elongated support member.

20. The method of claim 12, further comprising applying a force on a lower side of the link blocker, the force causing the link blocker to transition from the second position to the first position.
